(19) United States
(12) Patent Application Publication
(10) Pub. No.: US 2014/0168365 A1
(43) Pub. Date: Jun. 19, 2014

(54) METHOD FOR GENERATING, TRANSMITTING AND RECEIVING STEREOSCOPIC IMAGES, AND RELATED DEVICES

(71) Applicants: Giovanni Ballocca, Torino (IT); Paolo D'Amato, Roma (IT); Dario Pennisi, Fiumicino (IT)

(72) Inventors: Giovanni Ballocca, Torino (IT); Paolo D'Amato, Roma (IT); Dario Pennisi, Fiumicino (IT)

(73) Assignees: S.I.SV.EL SOCIETA' ITALIANA PER LO SVILUPPO DELL'ELETTRONICA S.P.A., NONE (TO) (IT); 3DSWITCH S.R.L., ROMA (IT) (IT)

(21) Appl. No.: 14/118,032

(22) PCT Filed: May 17, 2012
(86) PCT No.: PCT/IB2012/052486

§ 371 Date: Dec. 12, 2013

(30) Foreign Application Priority Data
May 17, 2011 (IT) TO2011A000439

(51) Int. Cl. H04N 13/00

(52) U.S. Cl. CPC H04N 13/0048
USPC 348/43

(57) ABSTRACT

A method for generating a stereoscopic video stream (101) including composite images (C), the composite images (C) including information about a right image (R) and a left image (L), wherein pixels of the right image (R) and pixels of the left image (L) are selected, and the selected pixels are entered into a composite image (C) of the stereoscopic video stream. All the pixels of the right image (R) and all the pixels of the left image (L) are entered into different positions in the composite image (C), by leaving one of the two images unchanged and breaking up the other one into two regions (R1, R2) including a plurality of pixels and entering the regions into the composite image (C).

### TECHNICAL FIELD

The present invention concerns the generation, storage, transmission, reception and reproduction of stereoscopic video streams, i.e. video streams which, when appropriately processed in a visualization device, produce sequences of images which are perceived as being three-dimensional by a viewer.

As known, the perception of three-dimensionality can be obtained by reproducing two images, one for the viewer's right eye and the other for the viewer's left eye.

A stereoscopic video stream therefore transports information about two sequences of images, corresponding to the right and left perspectives of an object or a scene.

The invention relates in particular to a method and a device for multiplexing the two images of the right and left perspectives (hereafter referred to as right image and left image) within a composite image which represents a frame of the stereoscopic video stream, hereafter also referred to as container frame.

In addition, the invention also relates to a method and a device for de-multiplexing said composite image, i.e. for extracting therefrom the right and left images entered by the multiplexing device.

### PRIOR ART

In order to reduce the bandwidth required to transmit a stereoscopic video stream, it is known in the art to multiplex the right and left images into a single composite image of a stereoscopic video stream.

A first example is the so-called side-by-side multiplexing, wherein the right image and the left image are sub-sampled horizontally and are arranged side by side in the same frame of a stereoscopic video stream.

This type of multiplexing has the drawback that the horizontal resolution is halved while the vertical resolution is left unchanged.

Another example is the so-called top-bottom multiplexing, wherein the right image and the left image are sub-sampled vertically and are arranged one on top of the other in the same frame of a stereoscopic video stream.

This type of multiplexing has the drawback that the vertical resolution is halved while the horizontal resolution is left unchanged.

There are also other more sophisticated methods, such as, for example, the one disclosed in patent application WO03/088682. This application describes the use of a chessboard sampling in order to decimate the number of pixels that compose the right and left images. The pixels selected for the frames of the right and left images are compressed “geometrically” into the side-by-side format (the blanks created in column 1 by removing the respective pixels are filled with the pixels of column 2, and so on). During the decoding step for presenting the image on a screen, the frames of the right and left images are brought back to their original format, and the missing pixels are reconstructed by applying suitable interpolation techniques. This method allows the ratio between horizontal and vertical resolution to be kept constant, but it reduces the diagonal resolution and also alters the correlation among the pixels of the image by introducing high-frequency spatial spectral components which would otherwise be absent. This may reduce the efficiency of the subsequent compression step (e.g. MPEG2 or MPEG4 or H.264 compression) while also increasing the bit-rate of the compressed video stream.

Further methods for multiplexing the right and left images are known from patent application WO2008/153863.

One of these methods provides for executing a 70% scaling of the right and left images; the scaled images are then broken up into blocks of 8×8 pixels.

The blocks of each scaled image can be compacted into an area equal to approximately half the composite image.

This method has the drawback that the redistribution of the blocks modifies the spatial correlation among the blocks that compose the image by introducing high-frequency spatial spectral components, thereby reducing compression efficiency.

Moreover, the scaling operations and the segmentation of each image into a large number of blocks involve a high computational cost and therefore increase the complexity of the multiplexing and de-multiplexing devices.

Another of these methods applies diagonal scaling to each right and left image, so that the original image is deformed into a parallelogram. The two parallelograms are then broken up into triangular regions, and a rectangular composite image is composed wherein the triangular regions obtained by breaking up the two parallelograms are reorganized and rearranged. The triangular regions of the right and left images are organized in a manner such that they are separated by a diagonal of the composite image.

Like the top-bottom and side-by-side solutions, this solution also suffers from the drawback of altering the ratio (balance) between horizontal and vertical resolution. In addition, the subdivision into a large number of triangular regions rearranged within the stereoscopic frame causes the subsequent compression step (e.g. MPEG2, MPEG4 or H.264), prior to transmission on the communication channel, to generate artifacts in the boundary areas between the triangular regions. Said artifacts may, for example, be produced by a motion estimation procedure carried out by a compression process according to the H.264 standard.

A further drawback of this solution concerns the computational complexity required by the operations for scaling the right and left images, and by the following operations for segmenting and rototranslating the triangular regions.

The applicant filed the International Patent Application PCT/IB2010/055918, disclosing a method, as defined in claim 1 as filed, for generating a stereoscopic video stream comprising composite images, said composite images comprising information about a right image and a left image, wherein pixels of said right image and pixels of said left image are selected, and said selected pixels are entered into a composite image of said stereoscopic video stream, the method being characterized in that all the pixels of said right image and all the pixels of said left image are entered into said composite image by leaving one of said two images unchanged and breaking up the other one into three regions comprising a plurality of pixels and entering said regions into said composite image.

Said method is related to the subdivision of the other image into three rectangular regions, and on how to arrange said three regions in the composite image.

However the above described method leaves some room for improvements, due primarily to the following problems.

If the number of regions could be reduced, this would allow to reduce the computational resources needed both at the encoding side and at the decoding side. Besides, since the artifacts introduced by the compression techniques are substantially concentrated along the internal boundaries, if the length of such internal boundaries could be reduced, the quality degradation of the reconstructed picture could also be reduced, especially in case of high compression rates.

### BRIEF DESCRIPTION OF THE INVENTION

It is the object of the present invention to provide a multiplexing method and a de-multiplexing method (as well as related devices) for multiplexing and de-multiplexing the right and left images which allow to overcome the drawbacks of the prior art.

In particular, it is one object of the present invention to provide a multiplexing method and a de-multiplexing method (and related devices) for multiplexing and de-multiplexing the right and left images which allow to preserve the balance between horizontal and vertical resolution.

It is another object of the present invention to provide a multiplexing method (and a related device) for multiplexing the right and left images which allows a high compression rate to be subsequently applied while minimizing the generation of distortions or artifacts.

It is a further object of the present invention to provide a multiplexing method and a de-multiplexing method (and related devices) characterized by a reduced computational cost.

It is a further object of the present invention to provide a multiplexing method and a de-multiplexing method (and related devices) characterized by a minor presence of artifacts and degradation of the image quality in the reassembled image.

These and other objects of the present invention are achieved through a multiplexing method and a de-multiplexing method (and related devices) for multiplexing and de-multiplexing the right and left images incorporating the features set out in the appended claims, which are intended as an integral part of the present description.

The general idea at the basis of the present invention is to enter two images into a composite image whose number of pixels is greater than or equal to the sum of the pixels of the two images to be multiplexed, e.g. the right image and the left image.

The pixels of the first image (e.g. the left image) are entered into the composite image without undergoing any changes, whereas the second image is subdivided into two regions whose pixels are arranged in free areas of the composite image.

This solution offers the advantage that one of the two images is left unchanged, which results in better quality of the reconstructed image.

The second image is broken up into two regions, so as to maximize the spatial correlation among the pixels and to reduce the generation of artifacts during the compression phase.

Subdividing one of the two stereoscopic images into three regions prevents most of the existing decoders from reconstructing the image without the addition of ad hoc functions, due to the lack of appropriate resources; reducing the subdivision into two regions may allow existing decoders with Picture in Picture (PIP) functionality to use it for reassembling the image thus reducing the amount of software changes needed to implement the invention in current decoders.

It is a particular object of the present invention a method for generating a stereoscopic video stream comprising composite images, said composite images comprising information about a right image and a left image, wherein

pixels of said right image (R) and pixels of said left image are selected, and said selected pixels are entered into a composite image of said stereoscopic video stream, the method being characterized in that all the pixels of said right image and all the pixels of said left image are entered into different positions in said composite image, by leaving one of said two images unchanged and breaking up the other one into two regions (R1, R2) comprising a plurality of pixels and entering said regions into said composite image.

Further objects of the present invention are a method for reconstructing a pair of images by starting from a composite image, a device for generating composite images, a device for reconstructing a pair of images starting from a composite image, and a stereoscopic video stream.

Further objects and advantages of the present invention will become more apparent from the following descriptions of some embodiments thereof, which are supplied by way of non-limiting example.

### BRIEF DESCRIPTION OF THE DRAWINGS

Said embodiments will be described with reference to the annexed drawings, wherein:

FIG. 1 shows a block diagram of a device for multiplexing the right image and the left image into a composite image;

FIG. 2 is a flow chart of a method executed by the device of FIG. 1;

FIG. 3 shows a first phase of constructing a composite image according to one embodiment of the present invention;

FIG. 4 shows a first form of disassembly of an image to be entered into a composite image;

FIGS. 5a and 5b show a first and a second form of a composite image that includes the image of FIG. 4.

FIG. 6 shows a second form of disassembly of an image to be entered into a composite image.

FIGS. 7a and 7b show a first and a second form of a composite image that includes the image of FIG. 6.

FIG. 8 shows a third form of disassembly of an image to be entered into a composite image.

FIGS. 9a and 9b show a first and a second form of a composite image that includes the image of FIG. 8.

FIG. 10 shows a fourth form of disassembly of an image to be entered into a composite image.

FIGS. 11a and 11b show a first and a second form of a composite image that includes the image of FIG. 10.

FIG. 12 shows a boundary region of the disassembled image to be replied in the composite image.

FIG. 13 shows a possible way to place the boundary region of FIG. 12 in the composite image.

FIG. 14 shows what sub-region of the boundary region of the FIGS. 12 and 13 can be extracted from the composite image.

FIG. 15 shows how the sub-region of FIG. 14 can be overwritten in the reassembled image for eliminating the artifacts in the reconstructed image after reassembling.

FIG. 16 shows a block diagram of a receiver for receiving a composite image generated according to the method of the present invention.

FIG. 17 shows some phases of reconstructing the left and right images contained in a composite image according to any form shown in the previous figures.

Where appropriate, similar structures, components, materials and/or elements are designated by means of similar references.

### DETAILED DESCRIPTION OF THE INVENTION

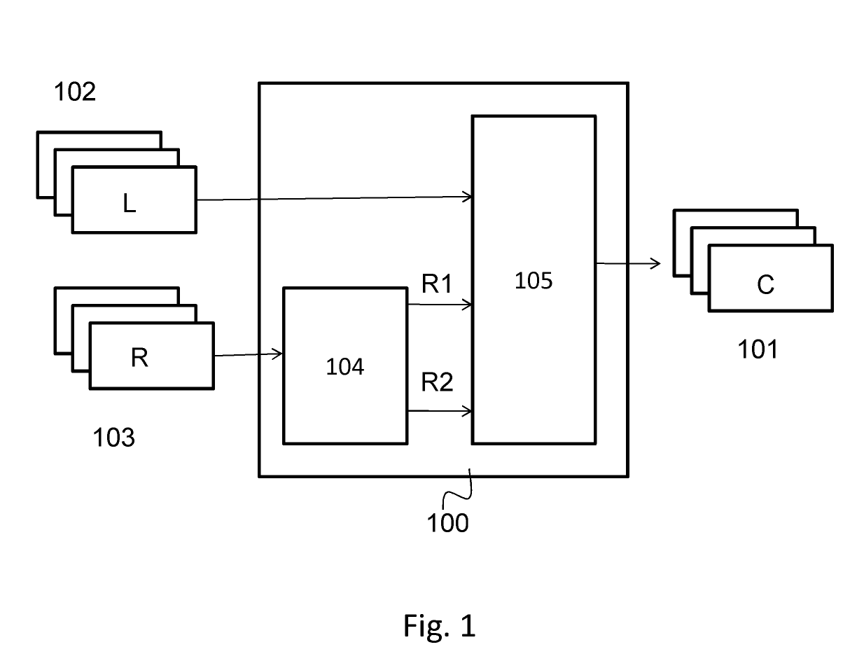

FIG. 1 shows the block diagram of a device 100 for generating a stereoscopic video stream 101.

In FIG. 1 the device 100 receives two sequences of images 102 and 103, e.g. two video streams, intended for the left eye (L) and for the right eye (R), respectively.

The device 100 allows to implement a method for multiplexing two images of the two sequences 102 and 103.

In order to implement the method for multiplexing the right and left images, the device 100 comprises a disassembler module 104 for breaking up an input image (the right image in the example of FIG. 1) into two sub-images, each corresponding to one region of the received image, and an assembler module 105 capable of entering the pixels of received images into a single composite image to be provided at its output.

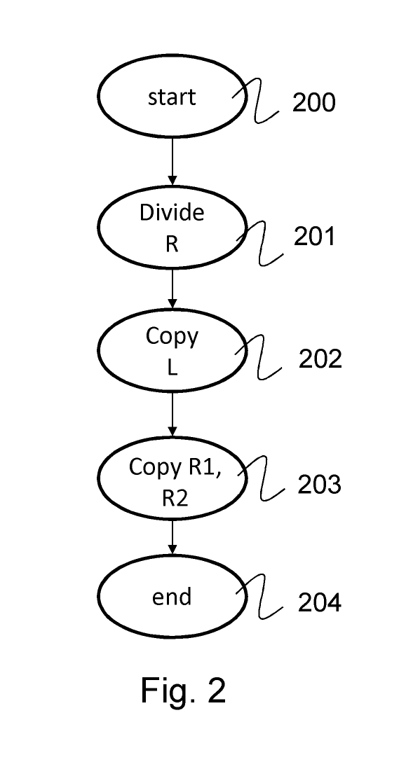

One example of a multiplexing method implemented by the device 100 will now be described with reference to FIG. 2.

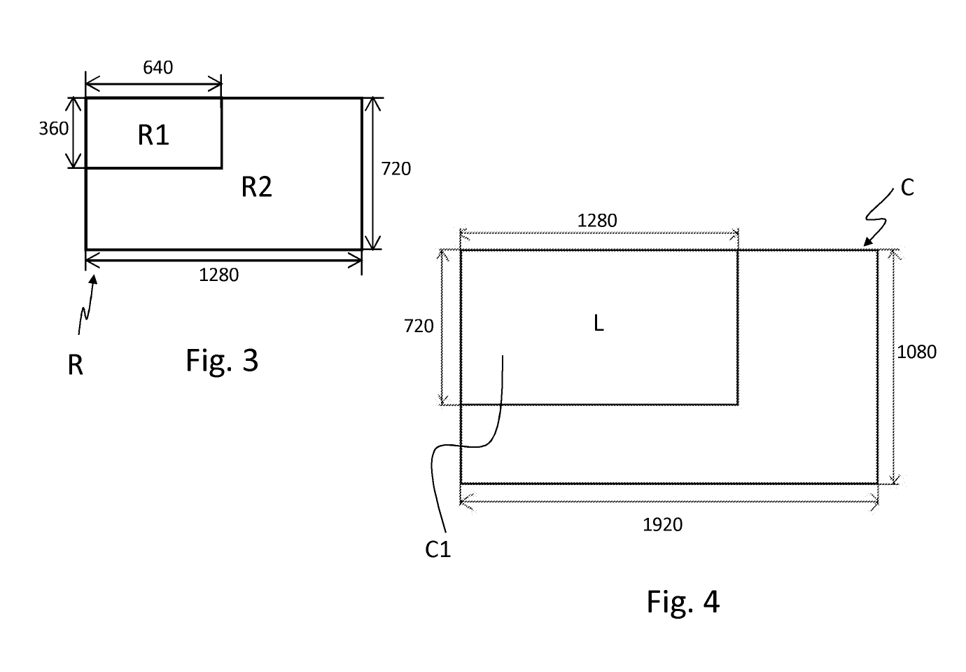

The method starts in step 200. Subsequently (step 201), one of the two input images (right or left) is broken up into two regions, as shown in FIG. 3. In the example of FIG. 3, the disassembled image is a frame R of a video stream 720 p, i.e. a progressive format with a resolution of 1280×720 pixels.

The frame R of FIG. 3 comes from the video stream 103 which carries the images intended for the right eye, and is disassembled into two regions R1 and R2.

The disassembly of the image R is obtained by dividing it into two parts.

The rectangular region R1 has a size of 640×360 pixels and is obtained by taking the first 640 pixels of the first 360 rows. The region R2 is L-shaped, and is obtained by taking the pixels from 641 to 1280 of the first 360 rows and all the pixels of the last 360 rows.

In the example of FIG. 1, the operation of disassembling the image R is carried out by the module 104, which receives an input image R (in this case the frame R) and outputs two sub-images (i.e. two groups of pixels) corresponding to the two regions R1, and R2. Subsequently (steps 202 and 203) the composite image C is constructed, which comprises the information pertaining to both the right and the left input images; in the example described herein, said composite image C is a frame of the output stereoscopic video stream, and therefore it is also referred to as container frame.

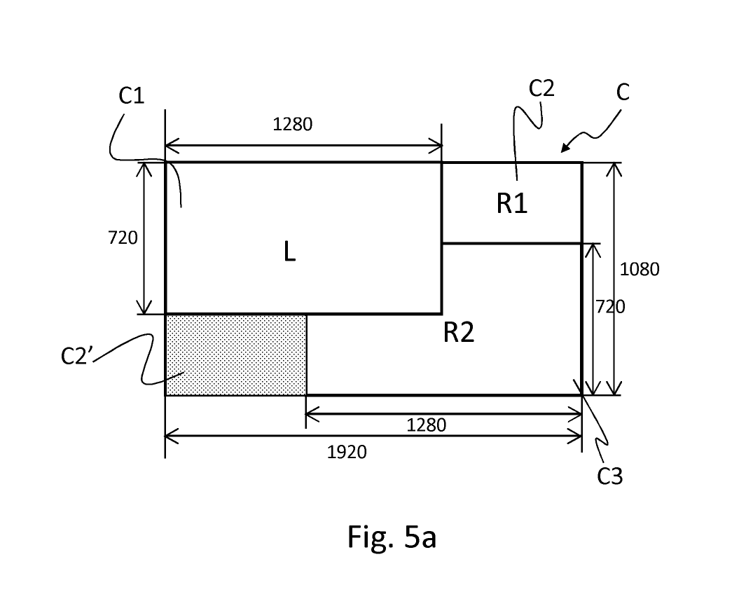

First of all (step 202), the input image received by the device 100 and not disassembled by the device 104 (the left image L in the example of FIG. 1) is entered unchanged into a container frame which is sized in a manner such as to include all the pixels of both input images. For example, if the input images have a size of 1280×720 pixels, then a container frame suitable for containing both will be a frame of 1920×1080 pixels, e.g. a frame of a video stream of the 1080 p type (progressive format with 1920×1080 pixels. In the example of FIG. 4, the left image L is entered into the container frame C and positioned in the upper left corner. This is obtained by copying the 1280×720 pixels of the image L into an area C1 consisting of the first 1280 pixels of the first 720 rows of the container frame C.

When in the following description reference is made to entering an image into a frame, or transferring or copying pixels from one frame to another, it is understood that this means to execute a procedure which generates (by using hardware and/or software means) a new frame comprising the same pixels as the source image.

The (software and/or hardware) techniques for reproducing a source image (or a group of pixels of a source image) into a target image are considered to be unimportant for the purposes of the present invention and will not be discussed herein any further, in that they are per se known to those skilled in the art.

In the next step 203, the image disassembled in step 201 by the module 104 is entered into the container frame. This is achieved by the module 105 by copying the pixels of the disassembled image into the container frame C in the areas thereof which were not occupied by the image L, i.e. areas being external to the area C1.

In order to attain the best possible compression and reduce the generation of artifacts when decompressing the video stream, the pixels of the sub-images outputted by the module 104 are copied by preserving the respective spatial relations. In other words, the regions R1, and R2 are copied into respective areas of the frame C without undergoing any deformation.

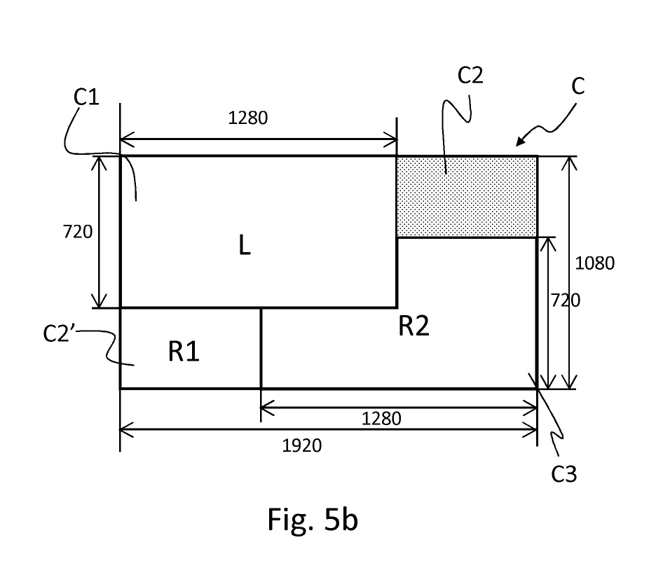

An example of the container frame C outputted by the module 105 is shown in FIG. 5a. The rectangular region R1 is copied into the last 640 pixels of the first 360 rows of the composite frame C (area C2), i.e. next to the previously copied image L.

The L-shaped region R2 is copied under the area C2, i.e. in the area C3, which comprises the last 640 pixels of the rows from 361 to 720 plus the last 1280 pixels of the last 360 rows.

The operations for entering the images L and R into the container frame do not imply any alterations to the balance between horizontal and vertical resolution.

There remains a rectangular region in the frame C composed by the first 640 pixels of the last 360 rows (region C2′) which can be used for other purposes, e.g. for any ancillary data or signalling: it is represented lightly darkened in FIG. 5a and in the other figures as well.

If such spare region is not used at all, the same RGB values are assigned to the remaining pixels of the frame C; for example, said remaining pixels may be all black. Once the transfer of both input images (and possibly also of the signal) into the container frame has been completed, the method implemented by the device 100 ends and the container frame can be compressed and transmitted on a communication channel and/or recorded onto a suitable medium (e.g. CD, DVD, Blu-ray, mass memory, etc.).

Since the multiplexing operations explained above do not alter the spatial relations among the pixels of one region or image, the video stream outputted by the device 100 can be compressed to a considerable extent while preserving good possibilities that the image will be reconstructed very faithfully to the transmitted one without creating significant artifacts.

Before describing further embodiments, it must be pointed out that the division of the frame R into two regions R1, and R2 corresponds to the division of the frame into the smallest possible number of regions, taking into account the space available in the composite image and the space occupied by the left image entered unchanged into the container frame.

Said smallest number is, in other words, the minimum number of regions necessary to occupy the space left available in the container frame C by the left image.

In general, therefore, the minimum number of regions into which the image must be disassembled is defined as a function of the format of the source images (right and left images) and of the target composite image (container frame C).

In other words, according to the invention, the image R can be split in only two regions R1 and R2, in the way shown in FIG. 4. In practice, the two images L and R are positioned at two opposite corners of the composite image C, in particular at the top left corner and at the bottom right corner respectively. The part R1 of the image R that is superimposed to the image L can be shifted either in the top right corner, as it is shown in the figure, or in the bottom left corner. The part R2 of the image R not superimposed to the image L, placed at the bottom right corner, has the form of an irregular polygon with six sides. This way the second image is broken up into the minimum number of regions (two).

The advantage of this solution is that the total length of internal boundaries is minimized, which contributes to reducing the generation of artifacts during the compression phase, and maximize the spatial correlation among the pixels.

Additionally the computational cost required by subdividing the R image and copying the two sub-images into the composite frame C is minimized, thus simplifying the structure of the multiplexing and de-multiplexing apparatus and the complexity of the assembling and disassembling procedure.

The arrangement shown in FIG. 5a represents just a first way to dispose the two images in the composite frame C according to the present invention: FIG. 5b shows a layout alternative to that of FIG. 5a, in which the region R1 has been placed in the first 640 pixels of the last 360 rows of C (area C2′), while the area C2 remains free of video information.

The arrangements of FIGS. 5a and 5b can be considered as alternative to each other (“dual arrangements”), since they simply differ in the allocation of R1, which is placed in the upper right corner of C in the former case and in the lower left corner of C in the latter case.

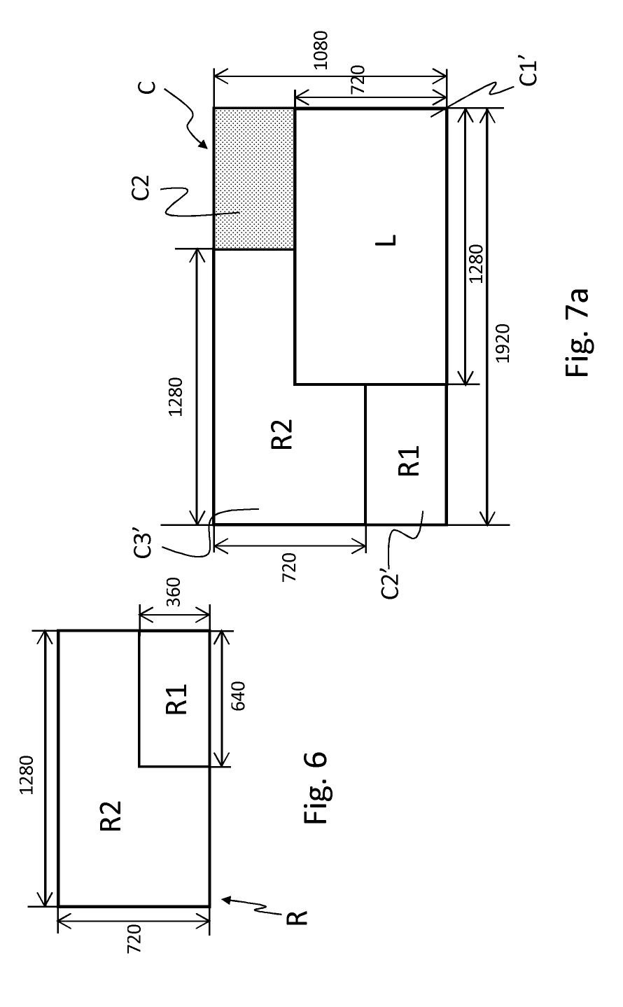

A second way to break up the image R in order to be placed in the composite frame C is shown in FIG. 6; R1 is obtained by extracting the last 640 pixels of the last 360 rows of R. The L-shaped sub-image R2 is composed by the remaining pixel of R, namely the first 360 rows plus the first 640 pixels of the last 360 rows.

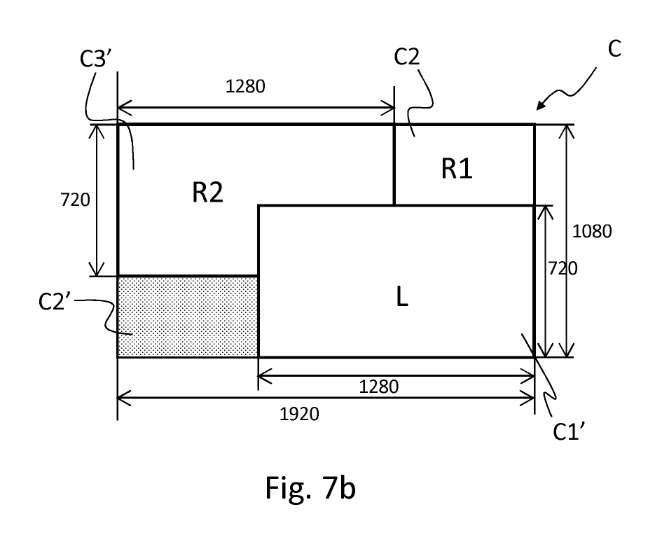

FIGS. 7a and 7b show the dual arrangements in which the regions R1 and R2 as obtained in FIG. 6 can be placed in the composite frame C after having placed the image L in its bottom right corner (area C1″), composed by the last 1280 pixels of the last 720 rows of C. The L-shaped R2 region is placed in upper left corner of C. The only difference between the two figures is the area of C occupied by the R1 sub-image, which is placed in the lower left (area C2′) and upper right (area C2) corner, respectively. Conversely the rectangular spare region occupies the upper right corner (area C2) and lower left corner (area C2′), respectively.

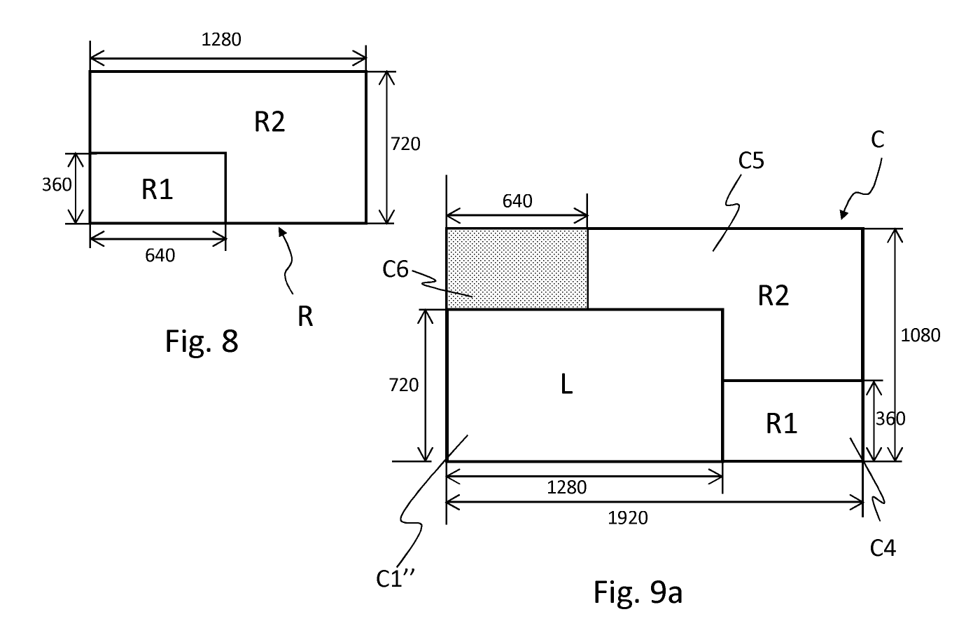

A third way to disassemble the image R in order to be placed in the composite frame C is shown in FIG. 8; R1 is obtained by extracting the first 640 pixels of the last 360 rows of R. The L-shaped sub-image R2 is composed by the remaining pixel of R, namely the first 360 rows plus the last 640 pixels of the last 360 rows.

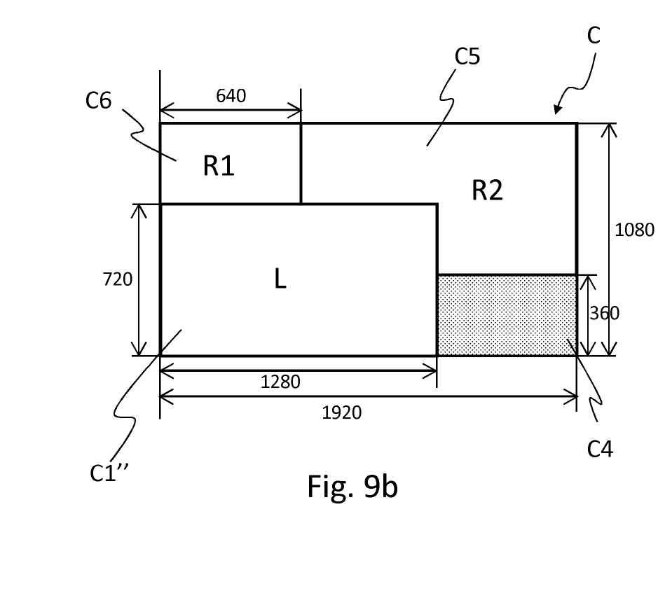

FIGS. 9a and 9b show the dual arrangements in which the regions R1 and R2 as obtained in FIG. 6 can be positioned in the composite frame C after having placed the image L in its bottom left corner (region C1″), composed by the first 1280 pixels of the last 720 rows of C. The L-shaped R2 region is placed in the upper right corner of C. The two figures differ in the position of the rectangular region R1, which is placed in the lower right (area C6) and upper left (area C4) corner, respectively. Conversely the rectangular spare region occupies the upper left (area C2) and lower right corner (area C2′), respectively.

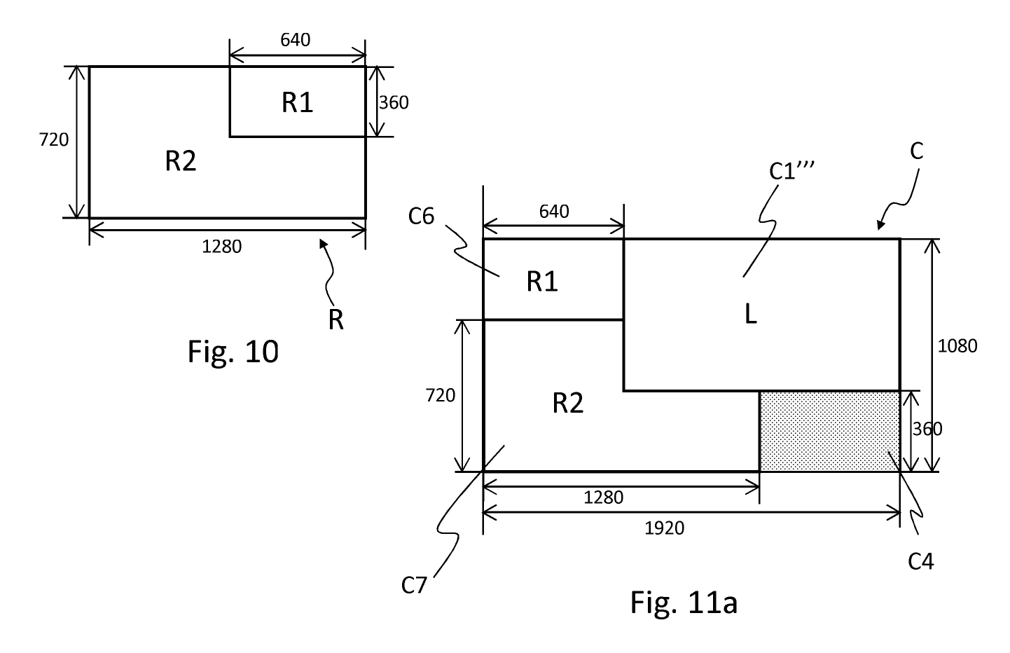

Finally, a fourth way to disassemble the image R is depicted in FIG. 10. The last 640 pixels of the first 360 rows are extracted to form the sub-image R1. The L-shaped region R2 is composed by the remaining pixel of R, namely the first 640 pixels of the first 360 rows plus the last 360 rows.

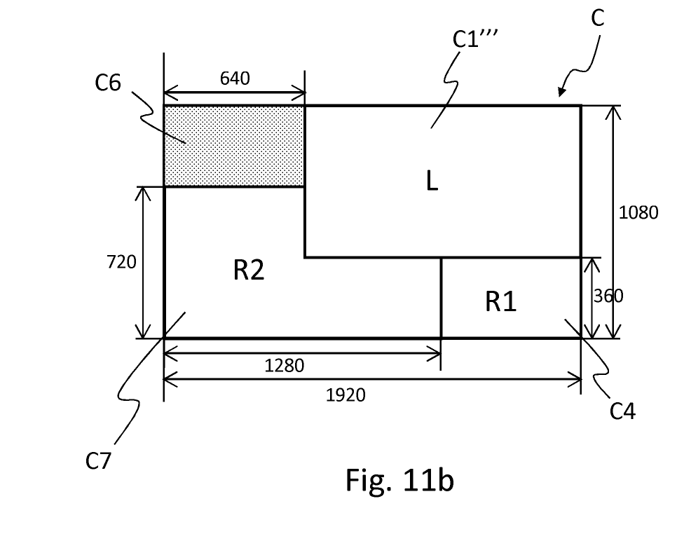

FIG. 11a and 11b show the dual arrangements in which the regions R1 and R2 as obtained in FIG. 6 can be positioned in the composite frame C after having placed the image L in its upper right corner (region C1′″), composed by the last 1280 pixels of the first 720 rows of C. The L-shaped R2 region is placed in the lower left corner of C. The two figures differ in the position of the rectangular region R1, which is placed in the top left (area C6) and bottom right (area C4) corner, respectively. Conversely the rectangular spare region occupies the upper left (area C2) and lower right corner (area C2′), respectively.

With this last couple of figures all the possible arrangements of the two regions of R and of L images into the composite frame C have been shown. So there are totally eight possible arrangements. Other eight arrangements are possible in splitting the image L into two sub-images L1 and L2 and leaving the other image R undivided. These eight arrangements can be easily derived from those shown in the figures described so far simply by exchanging the images R with L and the regions R1 and R2 with L1 and L2, respectively. Since these derived arrangements are quite trivial and immediate they are not further treated in the present disclosure.

Even if the arrangements shown are able to minimize the artifacts caused by the boundaries introduced by the splitting phase of R, some tests executed by the applicant show that, in case of high compression ratios, visible artifacts may be present in the reconstructed image after decoding.

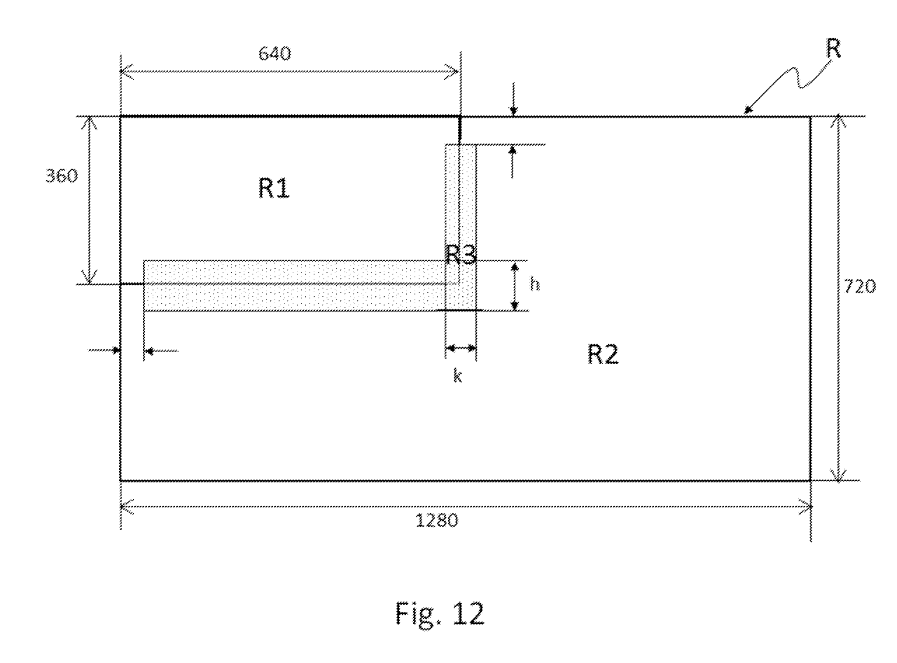

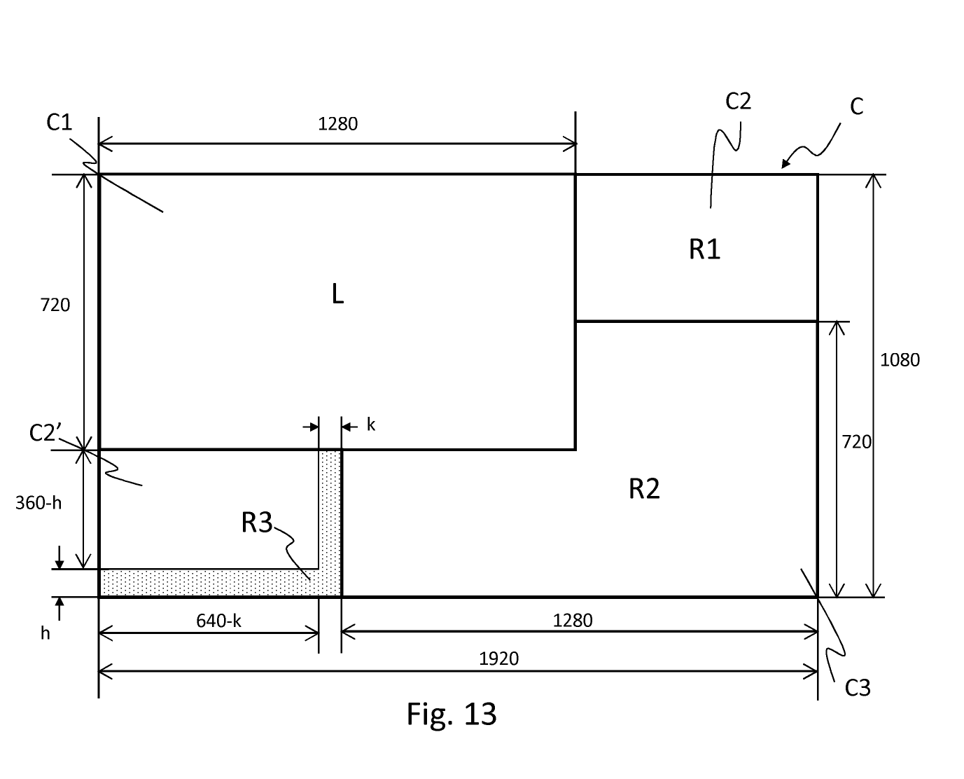

Advantageously, in order to further decrease the presence of artifacts on the boundary regions, it is possible to adopt the technique shown in FIGS. 12 and 13, applicable, as an example, on the disassembling scheme of FIG. 5a.

As a first embodiment, an additional L-shaped region R3 comprising the boundary region between R1 and R2 as shown in FIG. 12, can be replicated and inserted in the spare area C2′ as shown in FIG. 13. Such R3 region can have a constant width or two different widths, h and k, for the horizontal and vertical arms, respectively. The parameters h and k are integers greater than zero. The R3 region can eventually be placed symmetrically with respect to the internal boundary of R.

According to the tests made by the applicant the artifacts appear prevailingly close to the internal boundaries within the reconstructed image Rout. Thus the pixels of R1′ (corresponding to R1 after compression and decompression) and R2′ (corresponding to R2 after compression and decompression) placed near the internal boundaries of Rout can be discarded in the replication and can be replaced by the internal pixels of the region R3′ obtained after the compression and decompression operations of R3. Pixels at the edges of R3′ should be discarded, since they are close to another internal boundary and therefore may be affected by artifacts. Considering the respective size of R, L and C or C′, a strip of a certain set of border pixels can be placed in the spare area C2′, but this L shaped strip cannot include the pixels of the boundary region between R1 and R2 close to the external borders of R, as it clearly appears from the FIGS. 12 and 13.

This is not a great inconvenience, since the artifacts placed near the external borders of a picture are scarcely visible. However, if desired, also the two small regions that cannot be corrected in the way that has been described can be replicated and put in the empty space of the composite frame. This however increase the complication in the assembling and disassembling procedure and therefore is not a preferred solution.

Advantageously the L shaped region R3 is put in the spare area C2′ adjacent to its bottom right corner, so to maximize the length of the R3 arms that can be placed in the available region. As an example, the width of the horizontal arm of R3 can be of h=48 pixels, and only the internal n=16 pixels are used to reconstruct the R picture, while the adjacent 32 pixels are discarded, since they may be affected by artifacts, being close to a discontinuity within the composite frame C. Similarly the vertical arm of R can be large k=32 pixel, wherein only m=16 of them are used for the reconstruction of R.

Obviously the particular technique shown in FIGS. 12 and 13 can be applied, mutatis mutandis, also to the dual arrangement shown in FIG. 5b. The only difference is that the L-shaped region R3 is placed in the spare region C2 instead of C2′. Similarly the particular technique shown in FIGS. 12 and 13 can be applied, mutatis mutandis, to all other arrangements of the image R and of the composite frame C as shown in FIGS. 6-11. The only difference is that the internal boundary regions embraced by R3 are disposed differently and that region R3 is placed in different spare areas of C. The same applies to the other arrangements not shown in the figures obtainable by substituting R with L and R1 and R2 with L1 and L2.

Also, due to the fact that some tests show that the artefacts are more pronounced on the horizontal internal boundary between R1 and R2, instead of using an L-shaped internal region, it is possible to use an R3 region which includes only the pixels around the horizontal internal boundary. Of course, if it is desired to eliminate only the artefacts in the vertical internal edge, the R3 shaped region can be vertical. These embodiments are not shown in the figures, since they are obvious, given the explanation made above. The frame C thus obtained in any of the ways described so far is subsequently compressed and transmitted or saved to a storage medium (e.g. a DVD). For this purpose, compression means are provided which are adapted to compress an image or a video signal, along with means for recording and/or transmitting the compressed image or video signal.

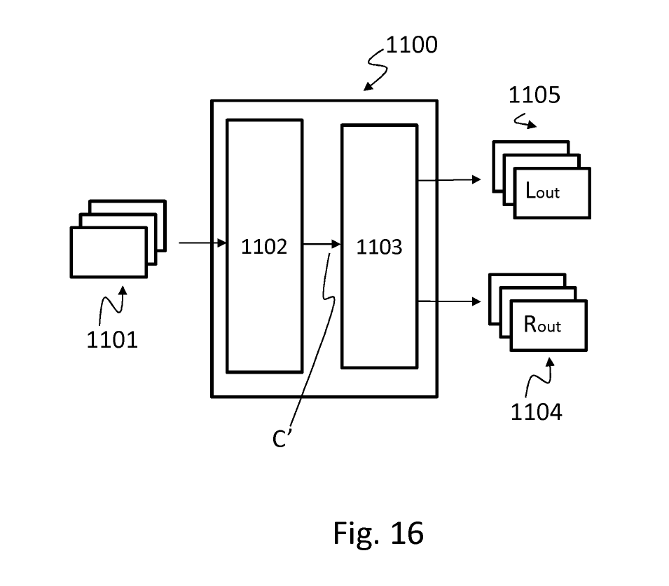

FIG. 16 shows a block diagram of a receiver 1100 which decompresses the received container frame (if compressed), reconstructs the two right and left images, and makes them available to a visualization device (e.g. a television set) allowing fruition of 3D contents. The receiver 1100 may be a set-top-box or a receiver built in a television set. The same remarks made for the receiver 1100 are also applicable to a reader (e.g. a DVD reader) which reads a container frame (possibly compressed) and processes it in order to obtain one pair of frames corresponding to the right and left images entered into the container frame (possibly compressed) read by the reader.

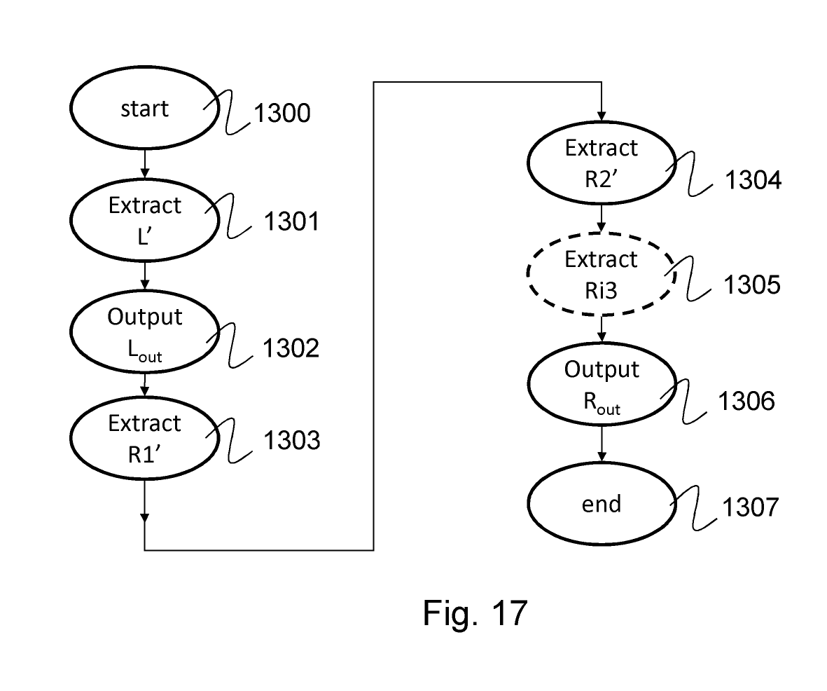

Referring back to FIG. 17, the receiver receives (via cable or antenna) a compressed stereoscopic video stream 1101 and decompresses it by means of a decompression module 1102, thereby obtaining a video stream comprising a sequence of frames C′ corresponding to the frames C. If there is an ideal channel or if container frames are being read from a mass memory or a data medium (Blu-ray, CD, DVD), the frames C′ correspond to the container frames C carrying the information about the right and left images, except for any artifacts introduced by the compression process.

These frames C′ are then supplied to a reconstruction module 1103, which executes an image reconstruction method as described below.

It is apparent that, if the video stream was not compressed, the decompression module 1102 may be omitted and the video signal may be supplied directly to the reconstruction module 1103.

The reconstruction process starts in step 1300, when the decompressed container frame C′ is received. The reconstruction process depends on the particular arrangements decided during the assembling process. Let us consider for example the composite frame shown in FIG. 5a. In such case the reconstruction module 1103 extracts (step 1301) the left image L′ (corresponding to the source image L) by copying the first 720×1280 pixels of the decompressed frame into a new frame Lout which is smaller than the container frame, e.g. a frame of a 720 p stream. The image Lout thus reconstructed is outputted to the receiver 1100 (step 1302).

Subsequently, the method provides for extracting the right source image R from the container frame C′.

The phase of extracting the right image begins by copying (step 1303) the area C2 included in the frame C′. More in detail, the last 640 pixels of the first 360 rows of C′ are copied into the corresponding first 640 columns of the first 360 rows of the new 720×1280 frame representing the reconstructed image Rout.

Then the area C3 containing the decompressed region R2′ (which was R2 before compression and decompression operations) is extracted (step 1305). From the decompressed frame C′ (which, as aforesaid, corresponds to the frame C of FIG. 5a), the pixels of the area C3 (corresponding to the source region R2) are copied in the L shaped remaining part of Rout, namely in the last 360 columns of the first 360 rows plus in the last 360 rows of Rout, thus obtaining the reconstructed image corresponding to the image R as assembled in FIG. 3.

At this point, the right image Rout has been fully reconstructed and can be outputted (step 1306).

Similar operations are performed by the receiver 1100, mutatis mutandis, for all other arrangements shown in the FIGS. 5b, 7a and 7b, 9a and 9b, 11a and 11b. The decompressed L image contained in the relevant rectangular area 720×1280 sized of C′ is extracted as a whole and put into the reconstructed Lout image. The areas of the composite frame C′ containing the decompressed sub-images R1 and R2 are placed again in their respective positions of Rout in the corresponding arrangement they had in the source image R as shown in FIGS. 4, 6, 8 and 10, as the case may be.

In case the particular technique of FIGS. 12 and 13 is used the receiver 1100 first performs the same operations already described for reconstructing Lout and Rout and then, as an additional step (1305 in FIG. 17) extracts' the internal region of R3′ (called Ri3) and overwrites the corresponding pixels around the internal boundaries of Rout, using at least some of the pixels of R3′.

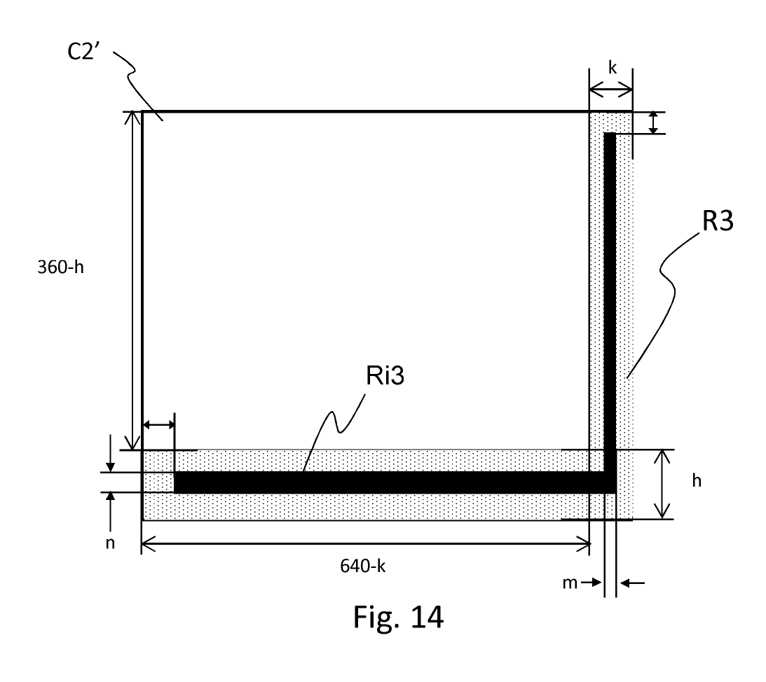

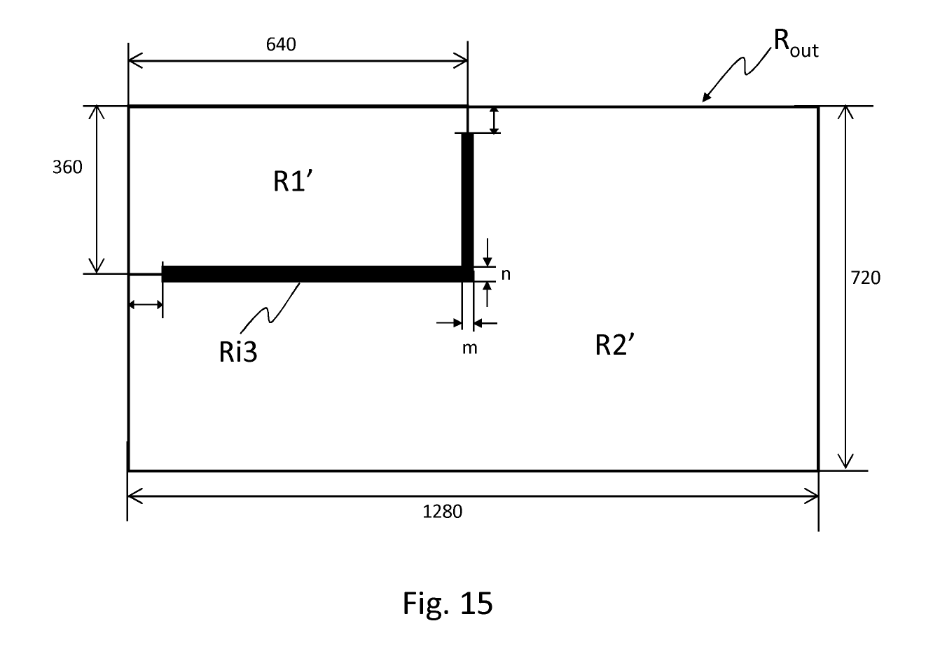

In the example shown in FIGS. 14 and 15 a strip of m vertical and n horizontal pixels staying in the inner part of R3 forming a region called Ri3′ is copied in the corresponding internal boundary region of Rout. Typically m and n can be integers greater than zero that can assume low values typically in a range between 3 and 16; they can be equal to each other or not, giving to Ri3 a constant or non constant width. The same technique can be used, mutatis mutandis, in case a rectangular shape of R3 has been used for covering only one of its arms, either horizontal or vertical.

It must be stressed that this is necessary only in the case of strong compression ratios, usually not used by the television broadcasters in which high image quality is mandatory, but that might be used in case of video streaming through the Internet or in general for distribution via a network or channel that has a limited bandwidth.

Thus, both at the encoder and at the decoder side, the use of the region R3′ and Ri3 is optional. A possibility would be to transmit region R3 and leave the freedom, at the decoder side, to use it or not: this would lead to two types of decoders, a simplified one and a more complex one with a better performance.

In a more complex embodiment the R3′ region can be mixed on top of the reconstructed image Rout with the so called “soft edge” technique which consists in cross fading the pixel values of the internal boundary region of Rout with the corresponding pixel values of R3′ so that R3′ contribution is maximized at the boundary between R1′ and R2′ and minimized at the R3′ boundaries.

The process for reconstructing the right and left images contained in the container frame C′ is thus completed (step 1307). Said process is repeated for each frame of the video stream received by the receiver 1100, so that the output will consist of two video streams 1104 and 1105 for the right image and for the left image, respectively.

Although the present invention has been illustrated so far with reference to some preferred and advantageous embodiments, it is clear that it is not limited to said embodiments and that many changes may be made thereto by a man skilled in the art wanting to combine into a composite image two images relating to two different perspectives (right and left) of an object or a scene.

For example, the electronic modules that provide the above described devices, in particular the device 100 and the receiver 1100, may be variously subdivided and distributed; furthermore, they may be provided in the form of hardware modules or as software algorithms implemented by a processor, in particular a video processor equipped with suitable memory areas for temporarily storing the input frames received. These modules may therefore execute in parallel or in series one or more of the video processing steps of the image multiplexing and de-multiplexing methods according to the present invention.

It is also apparent that, although the preferred embodiments refer to multiplexing two 720 p video streams into one 1080 p video stream, other formats may be used as well. The invention is also not limited to a particular type of arrangement of the composite image, since different solutions for generating the composite image may have specific advantages.

Finally, it is also apparent that the invention relates to any de-multiplexing method which allows a right image and a left image to be extracted from a composite image by reversing one of the above-described multiplexing processes falling within the protection scope of the present invention.

The invention therefore also relates to a method for generating a pair of images starting from a composite image, which comprises the steps of:
generating a first one (e.g. the left image) of said right and left images by copying one single group of contiguous pixels from a region of said composite image,
generating a second image (e.g. the right image) by copying other groups of contiguous pixels from two different regions of said composite image.

1. A method for generating a stereoscopic video stream comprising composite images (C), said composite images (C) comprising information about a right image (R) and a left image (L), wherein
pixels of said right image (R) and pixels of said left image (L) are selected, and
said selected pixels are entered into a composite image (C) of said stereoscopic video stream,
wherein all the pixels of said right image (R) and all the pixels of said left image (L) are entered into different positions in said composite image (C), by leaving one of said two images unchanged and breaking up the other one into two regions (R1, R2) comprising a plurality of pixels and entering said regions into said composite image (C).

2. A method according to claim 1, wherein a first (R2) of said two regions has an L shape, a second (R1) of said two regions has a rectangular shape.

3. A method according to claim 2, wherein said one (L) of said two images unchanged is placed at one corner of said composite image (C), said first (R2) of said two regions is placed at the opposite corner of said composite image (C) with respect to said one corner, said second (R1) of said two regions is placed in one portion of the space remained free in the composite image (C).

4. A method according to claim 1, wherein an additional region (R3) comprising at least part of the boundary region between said first and second (R1, R2) regions is inserted in said space left free in the composite image (C).

5. A method according to claim 1, wherein said regions comprise contiguous groups of columns of pixels of said image.

6. A method according to claim 1, wherein a sequence of right images (R) and a sequence of left images (L) are received,
a sequence of composite images is generated by starting from said sequences of right and left images,
said sequence of composite images (C) is compressed.

7. A method for reconstructing a pair of images by starting from a composite image (C′) as in claim 1, comprising the steps of:
generating a first one of said right (Rout) and left (Lout) images by copying one single group of contiguous pixels from a region of said composite image,
generating a second image of said right (Rout) and left (Lout) images by copying other groups of contiguous pixels from two different regions (R1′, R2′) of said composite image (C′).

8. A method according to claim 7, wherein at least a part (Ri3) of an additional region (R3′) comprising at least part of the boundary region between said first and second (R1′, R2′) regions, is overwritten in a corresponding boundary region of said second image (Rout).

9. A method according to claim 7, wherein an additional region (R3′) comprising at least part of the boundary region between said first and second (R1′, R2′) regions, is mixed on top of said second image (Rout), by cross fading the pixel values of the internal boundary region of said second image (Rout) with the corresponding pixel values of said additional region (R3′).

10. A device for generating composite images (C), comprising means for receiving a right image and a left image and means for generating a composite image (C) comprising information about said right image and said left image, and further comprising means for implementing the method according to claim 1.

11. A device for reconstructing a pair of images by starting from a composite image, characterized by comprising means for implementing the method according to claim 7.

12. A stereoscopic video stream comprising at least one composite image (C) generated by the method according to claim 1.
